(19) United States
(12) Patent Application Publication
(10) Pub. No.: US 2025/0166610 A1
(43) Pub. Date: May 22, 2025

(54) AUDIO PROCESSING METHOD, RECORDING MEDIUM, AND AUDIO PROCESSING SYSTEM

(71) Applicant: Panasonic Intellectual Property Management Co., Ltd., Osaka (JP)

(72) Inventors: Toya KITAGAWA, Osaka (JP); Masahiro Ishii, Hyogo (JP); Sara Asai, Osaka (JP)

(21) Appl. No.: 19/033,985

(22) Filed: Jan. 22, 2025

Related U.S. Application Data
(63) Continuation of application No. PCT/JP2022/044929, filed on Dec. 6, 2022.

(30) Foreign Application Priority Data
Jul. 26, 2022 (JP) 2022-118515

(51) Int. Cl. G10L 13/08; G10L 13/06

(52) U.S. Cl. CPC G10L 13/08; G10L 13/06

(57) ABSTRACT

In an audio processing method, event information concerning an event is obtained from an information source apparatus or an information source service, a character string to be spoken by a speech apparatus is determined based on the event information obtained, the character string determined is divided into one or more sub-character strings, an audio signal is generated from the character string, the audio signal is corrected by executing, on the audio signal generated, filter processing to apply a first filter according to a feature of a consonant for each of the one or more sub-character strings, and the audio signal corrected is output.

### CROSS REFERENCE TO RELATED APPLICATIONS

This is a continuation application of PCT International Application No. PCT/JP2022/044929 filed on Dec. 6, 2022, designating the United States of America, which is based on and claims priority of Japanese Patent Application No. 2022-118515 filed on Jul. 26, 2022. The entire disclosures of the above-identified applications, including the specifications, drawings and claims are incorporated herein by reference in their entirety.

### FIELD

The present disclosure relates to an audio processing method for processing a human speech sound coming out of a loudspeaker.

### BACKGROUND

For example, Patent Literature (PLT) 1 discloses a method for automatically adjusting an audio response to improve the intelligibility of a human speech sound received by a wireless receiver by automatically adjusting the audio response according to the ambient noise level. In this method for automatically adjusting an audio response, when there is high ambient noise, the relative gain of a high audio frequency is increased at the expense of low frequency response.

### CITATION LIST

### Patent Literature

PTL 1: Unexamined Patent Application Publication (Translation of PCT Application) No. 2000-508487

### SUMMARY

### Technical Problem

The present disclosure provides an audio processing method which facilitates hearing of a human speech sound by a user irrespective of the performance of a loudspeaker included in a speech apparatus.

### Solution to Problem

In the audio processing method according to one aspect of the present disclosure, event information concerning an event is obtained from an information source apparatus or an information source service; a character string to be spoken by a speech apparatus is determined based on the event information obtained; the character string determined is divided into one or more sub-character strings; an audio signal is generated from the character string; the audio signal is corrected by executing, on the audio signal generated, filter processing to apply a first filter according to a feature of a consonant for each of the one or more sub-character strings; and the audio signal corrected is output.

The recording medium according to one aspect of the present disclosure is a non-transitory computer-readable recording medium having recorded thereon a program for causing one or more processors to execute the audio processing method.

The audio processing system according to one aspect of the present disclosure includes: an input interface that obtains event information concerning an event from an information source apparatus or an information source service; a signal processing circuit that corrects an audio signal; and an output interface that outputs the audio signal corrected. The signal processing circuit: determines a character string to be spoken by a speech apparatus, based on the event information obtained; divides the character string determined into one or more sub-character strings; generates an audio signal from the character string; and corrects the audio signal by executing, on the audio signal generated, filter processing to apply a first filter according to a feature of a consonant for each of the one or more sub-character strings.

### Advantageous Effects

The audio processing method and the like according to the present disclosure have advantages in that hearing of the human speech sound by the user is facilitated irrespective of the performance of the loudspeaker included in the speech apparatus.

### BRIEF DESCRIPTION OF DRAWINGS

These and other advantages and features will become apparent from the following description thereof taken in conjunction with the accompanying Drawings, by way of non-limiting examples of embodiments disclosed herein.

FIG. 1 is a diagram illustrating frequency characteristics of a human speech sound when a speech apparatus is caused to output the human speech sound.

FIG. 2 is a diagram illustrating the frequency characteristics of a human speech sound when a filter processing is executed on the audio signal, and then the speech apparatus is caused to output the human speech sound.

FIG. 3 is a diagram illustrating the frequency characteristics of drive sounds output by electrical appliances.

FIG. 4 is a diagram illustrating the results of DRT performed by outputting a sound for evaluation by a robot vacuum cleaner under a noisy environment.

FIG. 5 is a diagram illustrating the results for the respective features of the consonants when DRT was performed by causing the robot vacuum cleaner to output the sounds for evaluation under a noisy environment.

FIG. 6 is a diagram illustrating the results for the respective features of the consonants when the DRT was performed by causing a pet camera to output the sounds for evaluation under a noisy environment.

FIG. 7 is a diagram illustrating an example of spectrograms obtained from the sound waveforms of the sounds for evaluation for the respective features of the consonants.

FIG. 8 is a diagram illustrating an example of spectrograms obtained from the sound waveforms of the sounds for evaluation for the respective features of the consonants.

FIG. 9 is a block diagram illustrating the entire configuration including the audio processing system according to the embodiment.

FIG. 10 is a diagram illustrating the correlation between the consonants and the features of the consonants.

FIG. 11 is a diagram illustrating the correlation between the features of the consonants and the frequency domain.

FIG. 12 is a flowchart illustrating an example of the operation of the audio processing system according to the embodiment.

### DESCRIPTION OF EMBODIMENT

### Underlying Knowledge Forming Basis of the Present Disclosure

### 1. Underlying Knowledge Forming Basis of the Present Disclosure

Initially, the viewpoint of the inventor will be described below.

Conventionally, there is a technique for causing a home appliance (speech apparatus) having a sound input/output function to speak by instructing the content of the speech and the timing of the speech to the home appliance. Here, the term “sound” indicates vibration of the air or the like that is perceivable at least to humans by the sense of hearing. For example, this technique is used to notify a user away from a home appliance (such as a laundry machine) of the content of an event occurring in the home appliance by causing a speech apparatus having a sound input/output function to speak. For example, the event can include occurrence of any error in the home appliance, the end of an operation which is being executed by the home appliance, or the like.

Here, for example, in appliances such as a television receiver in which it is assumed that the speech apparatus mainly outputs the human speech sound, the loudspeaker included in the speech apparatus has relatively high performance, which makes it easy for the user to hear the human speech sound output by the speech apparatus, that is, results in relatively high intelligibility of the human speech sound. In contrast, in appliances such as a robot vacuum cleaner in which it is assumed that the speech apparatus mainly outputs a system sound other than the human speech sound, such as a beep sound, the loudspeaker included in the speech apparatus has relatively low performance, which makes it difficult for the user to hear the human speech sound output by the speech apparatus, that is, may result in relatively low intelligibility of the human speech sound.

Thus, in consideration of the above problem, the inventor has conducted research on a technique that facilitates hearing of a human speech sound, or relatively increases the intelligibility of the human speech sound by a user irrespective of the performance of the loudspeaker included in a speech apparatus.

### 1-1. Frequency Characteristics of Human Speech Sound Output by Speech Apparatus

Initially, the inventor has conducted on an improvement in intelligibility of the human speech sound output by a speech apparatus by executing filter processing on an audio signal that is converted into an acoustic wave and output by the speech apparatus. The term “filter processing” used herein indicates processing that amplifies the power (sound pressure level) of the audio signal in a specific frequency bandwidth.

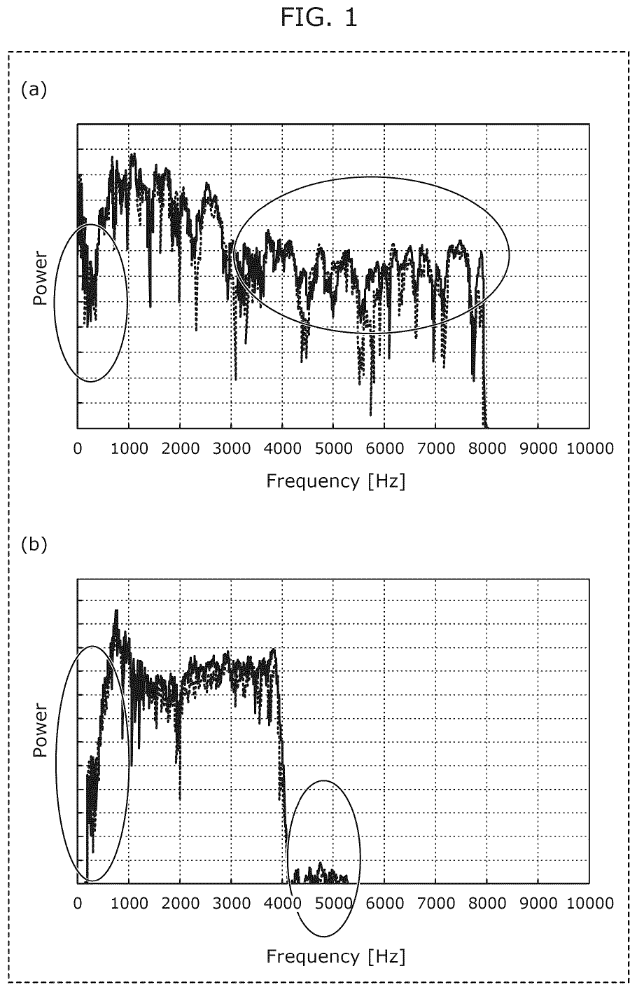

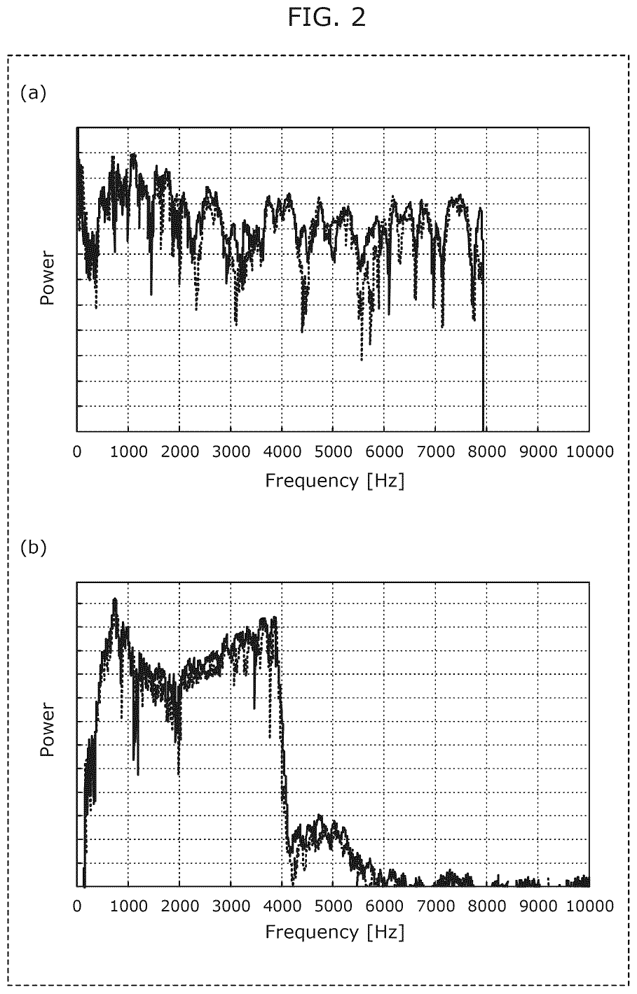

FIG. 1 is a diagram illustrating frequency characteristics of a human speech sound when a speech apparatus is caused to output the human speech sound. FIG. 2 is a diagram illustrating the frequency characteristics of a human speech sound when a filter processing is executed on the audio signal, and then the speech apparatus is caused to output the human speech sound. In both of FIGS. 1 and 2, the ordinate represents the power of the human speech sound, and the abscissa represents the frequency.

(a) of FIG. 1 is a diagram illustrating the frequency characteristics of the human speech sound output by a robot vacuum cleaner as a speech apparatus, and (a) of FIG. 2 is a diagram illustrating the frequency characteristics of a human speech sound output by the robot vacuum cleaner when a filter processing is executed. (b) of FIG. 1 is a diagram illustrating the frequency characteristics of a human speech sound output by a pet camera as a speech apparatus, and (b) of FIG. 2 is a diagram illustrating the frequency characteristics of a human speech sound output by the pet camera when a filter processing is executed. The robot vacuum cleaner and the pet camera are appliances in which it is assumed that the system sound other than the human speech sound is mainly output.

As illustrated in (a) of FIG. 1, in the human speech sound output by the robot vacuum cleaner, compared to other frequency domains, the power is reduced in a low frequency domain of 0 to 1 kHz and a high frequency domain of 3 kHz or higher (see the circles in the drawing). Thus, filter processing to amplify the power in the low frequency domain and the high frequency domain was executed on the audio signal. Then, as illustrated in (a) of FIG. 2, the power of the human speech sound output by the robot vacuum cleaner was increased in both of the low frequency domain and the high frequency domain, leading to a knowledge that the filter processing can contribute to an improvement in intelligibility of the human speech sound.

As illustrated in (b) of FIG. 1, compared to other frequency domains, the power of the human speech sound output by the pet camera is reduced in a low frequency domain of 0 to 1 kHz and a high frequency domain of 4 kHz or higher (see the circles in the drawing). Thus, likewise as above, the filter processing to amplify the power in the low frequency domain and the high frequency domain was executed on the audio signal. However, as illustrated in (b) of FIG. 2, the power of the human speech sound output by the pet camera was not increased in both of the low frequency domain and the high frequency domain, leading to a knowledge that the filter processing cannot contribute to an improvement in intelligibility of the human speech sound.

As described above, the inventor obtained the knowledge that when the filter processing is executed according to the frequency characteristics of the human speech sound output by the speech apparatus, depending on the type of speech apparatus, the filter processing can or cannot contribute to an improvement in intelligibility of the human speech sound. Hereinafter, the filter processing is also referred to as “filter processing according to the speech apparatus”.

### 1-2. DRT Test Using Japanese Sounds

Next, the inventor performed a diagnostic rhyme test (DRT), or an alternative sound intelligibility test using Japanese speech sounds by causing the speech apparatus to output the human speech sounds under a noisy environment. Here, the term “noisy environment” indicates an environment in which an electrical appliance near the speech apparatus is driven, and thus outputs a drive sound (noise).

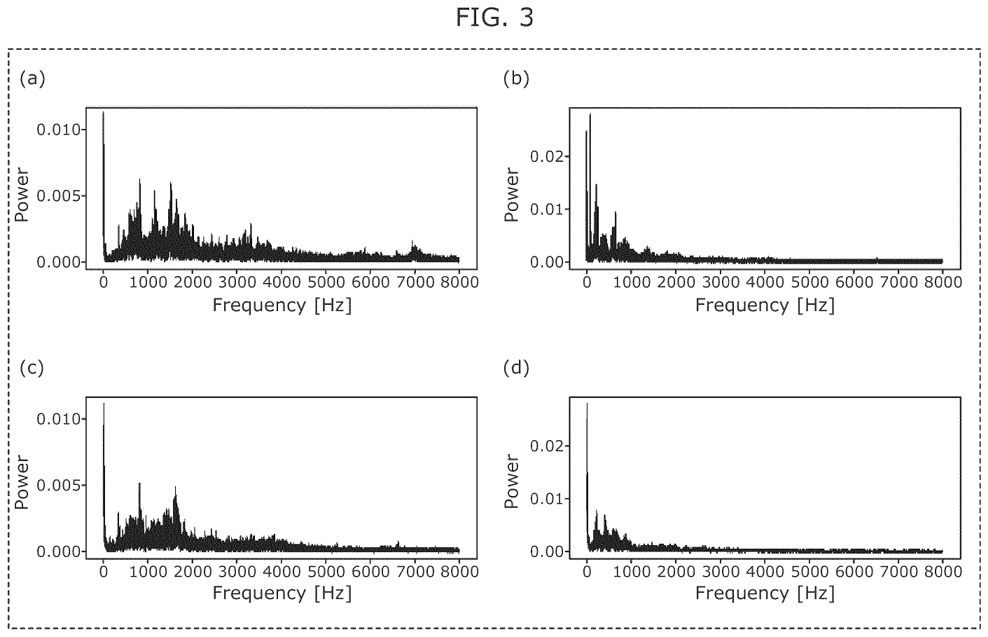

FIG. 3 is a diagram illustrating the frequency characteristics of drive sounds output by electrical appliances. In FIG. 3, the ordinate represents the power of the drive sound, and the abscissa represents the frequency. (a) of FIG. 3 illustrates the frequency characteristics of the drive sound output by a vacuum cleaner, and (b) of FIG. 3 illustrates the frequency characteristics of the drive sound output by a robot vacuum cleaner. (c) of FIG. 3 illustrates the frequency characteristics of a drive sound output by a dish washer, and (d) of FIG. 3 illustrates the frequency characteristics of a drive sound output by a laundry machine.

DRT is a test method for intelligibility in which a subject hears one of paired words having only a difference in one phoneme in the beginning of the word, and selects one of them. In DRT, consonants are classified based on six features, 10 pairs of words are prepared for each of the features, and sounds for evaluation in 120 words in total are tested. In DRT, the intelligibility of the human speech sound is represented by (the number of correct answers-the number of wrong answers)/total number of sounds for evaluation.

Here, the consonants are classified based on the six features, i.e., voicing, nasality, sustention, sibilation, graveness, and compactness.

The voicing corresponds to “vocalic-nonvocalic” in the classification of features of English phonemes by Jacobson, Fant, and Halle (JFH) (hereinafter, referred to as “JFH classification”), and is the classification of voiced sounds versus unvoiced sounds. The voiced sounds are sounds accompanied by vibration of the vocal cords, as in “zai”, and the unvoiced sounds are sounds without vibration of the vocal cords, as in “sai”.

The nasality corresponds to “nasal-oral” in the JFH classification, and is the classification based on nasality. Nasal sounds are sounds coming out through the nose without emission of the sound energy from the oral cavity, as in “man”, or sounds coming out through the nose with emission of the sound energy from the oral cavity, as in “ban”.

The sustention corresponds to “continuant-interrupted” in the JFH classification, and is the classification of continuant sounds versus other sounds (explosive sounds or affricates). The continuant sounds are sounds in which narrowing of the vocal tract is not restricted until the sound /h/ flows, as in “hashi”. The non-continuant sounds are explosive sounds as in “kashi”.

The sibilation corresponds to “strident-mellow” in the JFH classification, and is the classification related to irregularity of the waveform. The sounds with sibilation are sounds as in “chaku”, and the sounds without sibilation are sounds as in “kaku”.

The graveness corresponds to “grave-acute” in the JFH classification, which corresponds to grave sounds and acute sounds. The grave sounds are sounds as in “pai”, and the acute sounds are sounds as in “tai”.

The compactness corresponds to “compact-diffuse” in the JFH classification, and is the classification based on whether the energy on the spectrum concentrates on one formant of the frequency or diverges. The former is a sound as in “yaku”, and the latter is a sound as in “waku”.

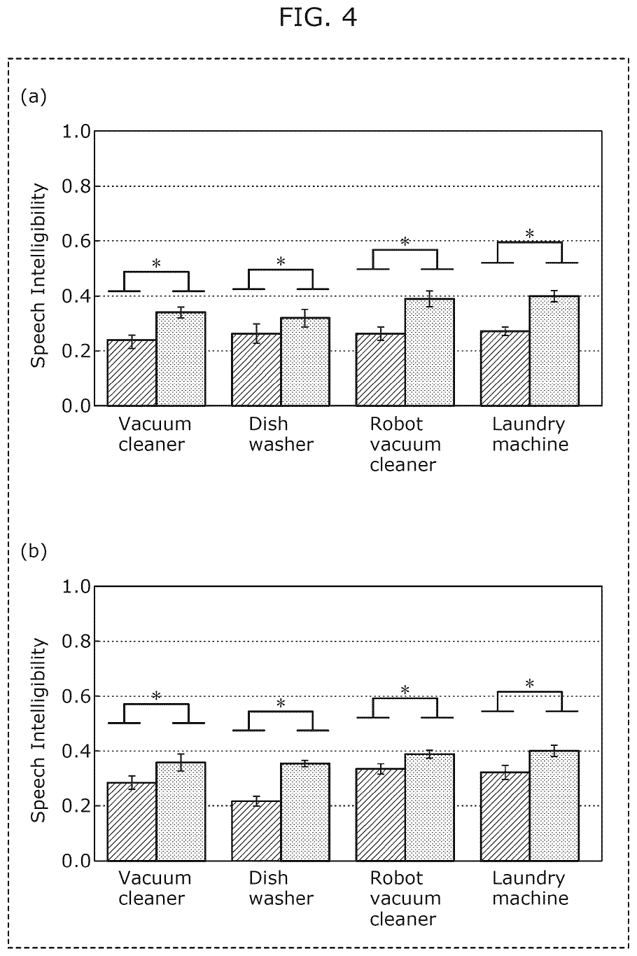

FIG. 4 is a diagram illustrating the results of DRT performed by outputting a sound for evaluation by a robot vacuum cleaner under a noisy environment. In FIG. 4, the ordinate represents the intelligibility of the human speech sound (Speech Intelligibility), and the abscissa represents the type of the noise source. In FIG. 4, the bar charts hatched with a solid line illustrate the results when the filter processing according to the speech apparatus was not executed, and the bar charts hatched with a dot illustrate the results when the filter processing was executed. (a) of FIG. 4 illustrates the results when the sound for evaluation was output from the robot vacuum cleaner by a female voice, and (b) of FIG. 4 illustrates the results when the sound for evaluation was output by the robot vacuum cleaner with a male voice.

As illustrated in FIG. 4, it was verified that the intelligibility of the human speech sound was improved by executing the filter processing in the cases where all the electrical appliances, i.e., the vacuum cleaner, the dish washer, the robot vacuum cleaner, and the laundry machine were the noise source. It was also verified that the intelligibility of the human speech sound was slightly increased in the case where the sound for evaluation was output by the robot vacuum cleaner with the female voice than in the case where the sound for evaluation was output by the robot vacuum cleaner with the male voice. However, the intelligibility of the human speech sound is 0.4 or lower and relatively low in all the cases where any of these electrical appliances was the noise source.

As described above, the inventor obtained the knowledge that only by executing the filter processing according to the speech apparatus, the intelligibility of the human speech sound under a noisy environment cannot be sufficiently improved.

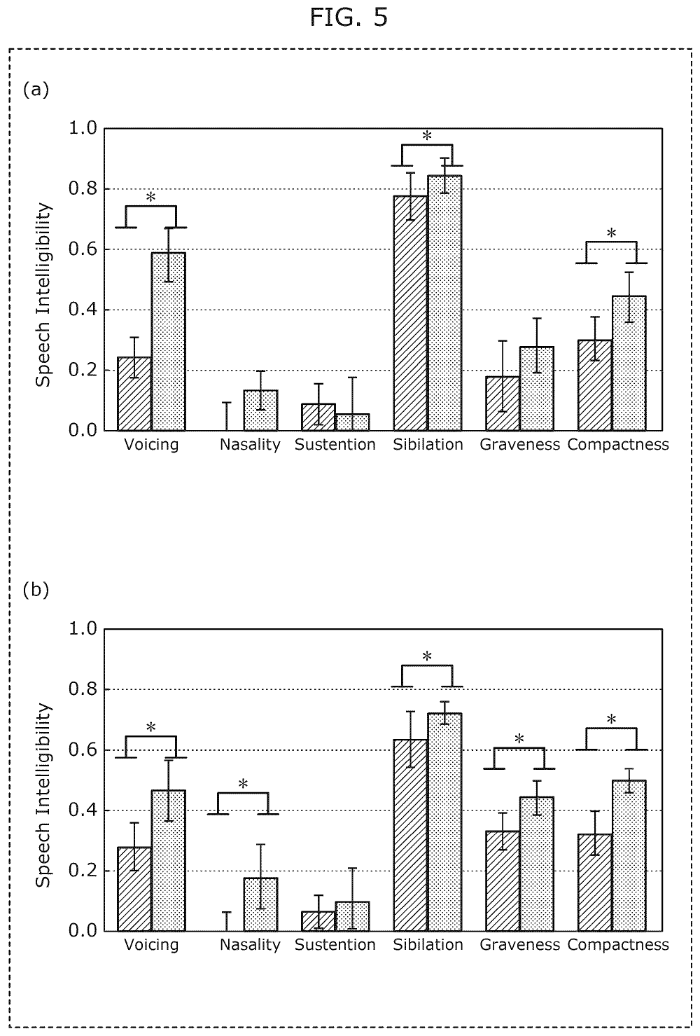

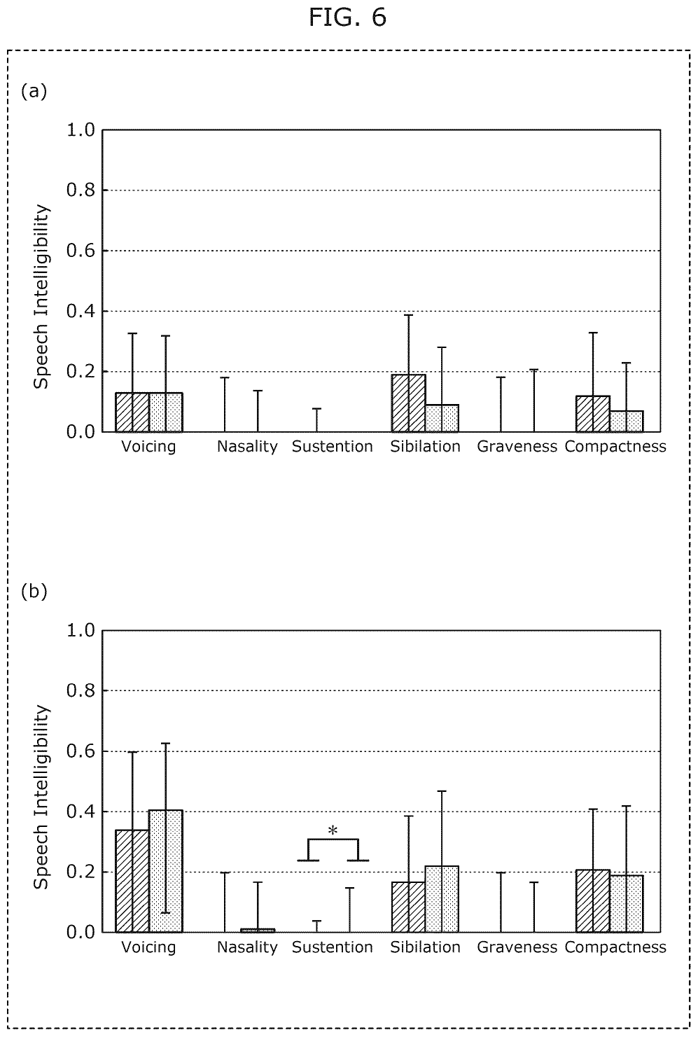

Here, the inventor has conducted more detailed research on the above-mentioned DRT. Specifically, the inventor has conducted research on the intelligibility of the human speech sound for the respective features of the consonants in the DRT. FIG. 5 is a diagram illustrating the results for the respective features of the consonants when the DRT was performed by causing the robot vacuum cleaner to output the sounds for evaluation under a noisy environment. FIG. 6 is a diagram illustrating the results for the respective features of the consonants when the DRT was performed by causing the pet camera to output the sounds for evaluation under a noisy environment.

In FIGS. 5 and 6, the ordinate represents the intelligibility of the human speech sound, and the abscissa represents the type of features of the consonants. In FIGS. 5 and 6, the bar chart hatched with a solid line illustrates the result when the filter processing according to the speech apparatus was not executed, and the bar chart hatched with a dot illustrates the results when the filter processing was executed. (a) of FIG. 5 and (a) of FIG. 6 illustrate the results when the noise source was the robot vacuum cleaner, and (b) of FIG. 5 and (b) of FIG. 6 illustrate the results when the noise source was the laundry machine.

As illustrated in FIGS. 5 and 6, it was revealed that there are some cases where the subject could not hear the sound for evaluation due to the feature of the consonant even when the filter processing was executed. For example, as illustrated in FIG. 5, when the robot vacuum cleaner is caused to output the sounds for evaluation, the intelligibilities of the sounds for evaluation corresponding to the voicing and the sibilation are relatively increased, while the intelligibilities of the sounds for evaluation corresponding to the other features of the consonants are relatively reduced. In particular, the intelligibilities of the sounds for evaluation corresponding to the nasality and the sustention are very low, and the subject can hardly hear the sounds for evaluation. For example, as illustrated in FIG. 6, when the pet camera is caused to output the sound for evaluation and the laundry machine is the noise source, the intelligibilities of the sounds for evaluation corresponding to the voicing are relatively increased, while the intelligibilities of the sounds for evaluation corresponding to the other features of the consonants are very low, and the subject can hardly hear the sounds for evaluation.

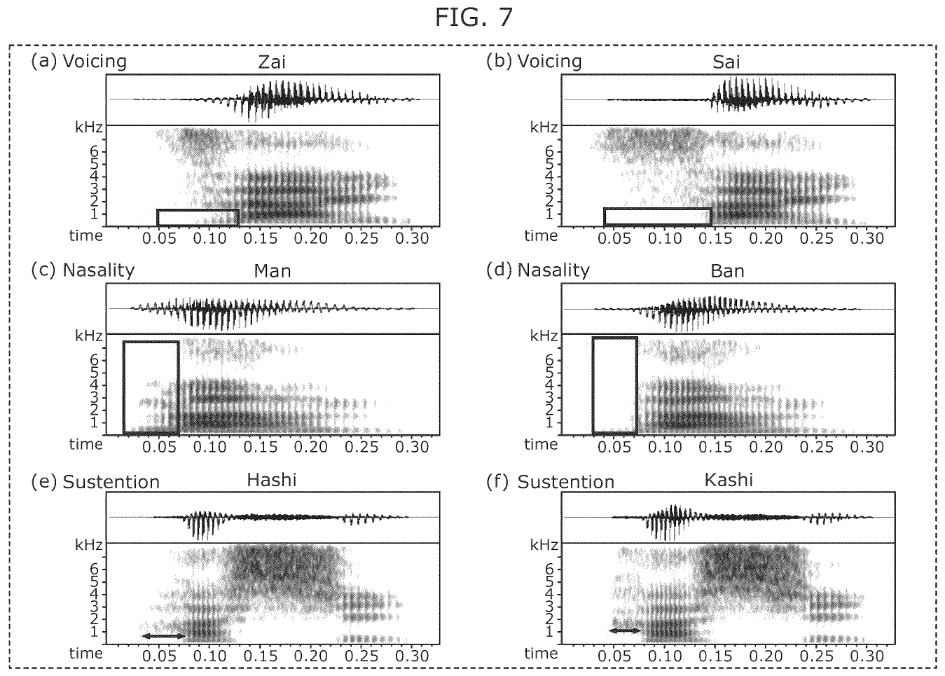

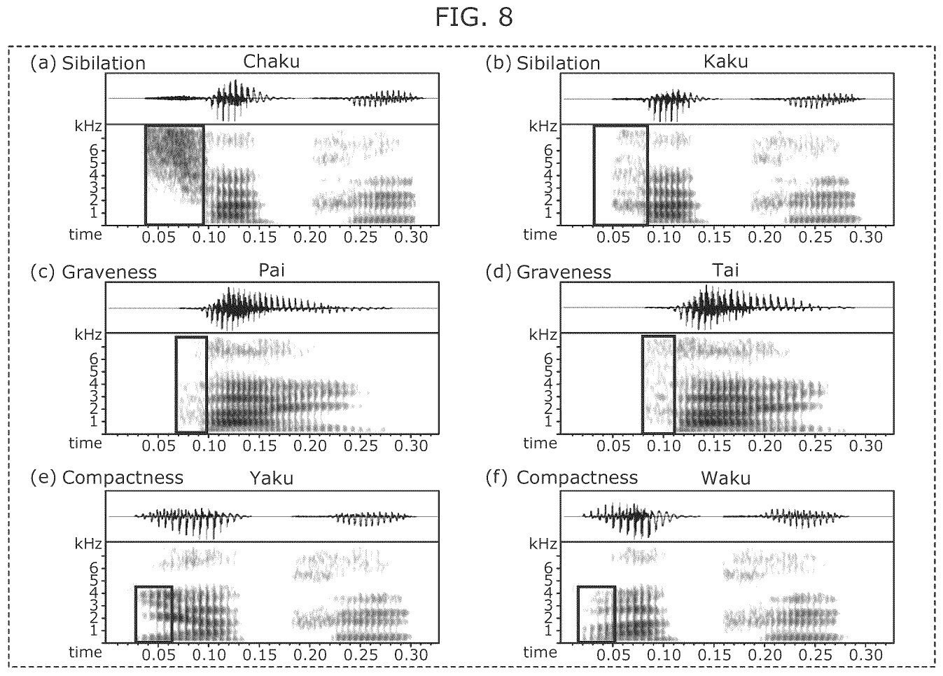

Thus, the inventor paid attention to the frequency characteristics for the respective features of the consonants. FIGS. 7 and 8 are diagrams illustrating examples of spectrograms obtained from the sound waveforms of the sounds for evaluation for the respective features of the consonants. In FIGS. 7 and 8, the upper domain represents the sound waveform, and the lower domain represents the spectrogram. The term “spectrogram” used here shows the frequency spectrum of each of the sounds for evaluation in a lapse of time.

(a) of FIG. 7 illustrates the spectrogram obtained from the sound waveform of a sound for evaluation “zai” corresponding to the voicing, and (b) of FIG. 7 illustrates the spectrogram obtained from the sound waveform of a sound for evaluation “sai” corresponding to the voicing. (c) of FIG. 7 illustrates the spectrogram obtained from the sound waveform of a sound for evaluation “man” corresponding to the nasality, and (d) of FIG. 7 illustrates the spectrogram obtained from the sound waveform of a sound for evaluation “ban” corresponding to the nasality. (e) of FIG. 7 illustrates the spectrogram obtained from the sound waveform of a sound for evaluation “hashi” corresponding to the sustention, and (f) of FIG. 7 illustrates the spectrogram obtained from the sound waveform of a sound for evaluation “kashi” corresponding to the sustention.

(a) of FIG. 8 illustrates the spectrogram obtained from the sound waveform of a sound for evaluation “chaku” corresponding to the sibilation, and (b) of FIG. 8 illustrates the spectrogram obtained from the sound waveform of a sound for evaluation “kaku” corresponding to the sibilation. (c) of FIG. 8 illustrates the spectrogram obtained from the sound waveform of a sound for evaluation “pai” corresponding to the graveness, and (d) of FIG. 8 illustrates the spectrogram obtained from the sound waveform of a sound for evaluation “tai” corresponding to the graveness. (e) of FIG. 8 illustrates the spectrogram obtained from the sound waveform of a sound for evaluation “yaku” corresponding to the compactness, and (f) of FIG. 8 illustrates the spectrogram obtained from the sound waveform of a sound for evaluation “waku” corresponding to the compactness.

As illustrated in FIGS. 7 and 8, the frequency spectra of the one phoneme in the beginning of the word are different for the respective features of the consonants. For example, as illustrated in the rectangular frames in (a) of FIG. 7 and (b) of FIG. 7, focusing on “za” and “sa” each corresponding to the one phoneme in the beginning of the word in the spectrograms of the sounds for evaluation corresponding to the voicing, the former contains a frequency component of 0 to 1 kHz, and the latter does not contain such a frequency component. For example, as illustrated in the rectangular frames in (a) of FIG. 8 and (b) of FIG. 8, focusing on “cha” and “ka” each corresponding to the one phoneme in the beginning of the word in the spectrograms of the sounds for evaluation corresponding to the sibilation, the former contains a large amount of a frequency component of 2 to 6 kHz, and the latter hardly contains such a frequency component. As illustrated by the arrows or in the rectangular frames FIGS. 7 and 8, the frequency spectra of the one phoneme in the beginning of the word are also different in the other features of the consonants.

Here, focusing on the results of the sounds for evaluation corresponding to the voicing in (a) of FIG. 5 and (b) of FIG. 5, the intelligibilities of the human speech sounds significantly increased the case where the filter processing according to the speech apparatus was executed, compared to the case where the filter processing was not executed. This is because the frequency domain effective in hearing the one phoneme in the beginning of the word in the sound for evaluation corresponding to the voicing is 0 to 1 kHz, and is emphasized by the filter processing to amplify the power in the low frequency domain of 0 to 1 kHz.

As described above, the inventor obtained a knowledge that hearing of the one phoneme in the beginning of the word by people was facilitated by emphasizing the frequency domain of the audio signal according to the feature of the consonant, resulting in an improvement in intelligibility of the human speech sound.

The inventor has created the present disclosure in consideration of the description above.

Hereinafter, an embodiment will be specifically described with reference to the drawings. The embodiment described below illustrates general or specific examples. Numeric values, shapes, materials, components, arrangement positions of components and connection forms thereof, steps, order of steps, and the like shown in the embodiment below are exemplary, and should not be construed as limitations to the present disclosure. Moreover, among the components of the embodiments below, the components not described in an independent claim will be described as optional components.

The drawings are schematic views, and are not necessarily precise illustrations. In the drawings, in some cases, identical reference signs will be given to substantially identical configurations, and duplication of descriptions will be omitted or simplified.

### Embodiment

### 2. Configuration

### 2-1. Entire Configuration

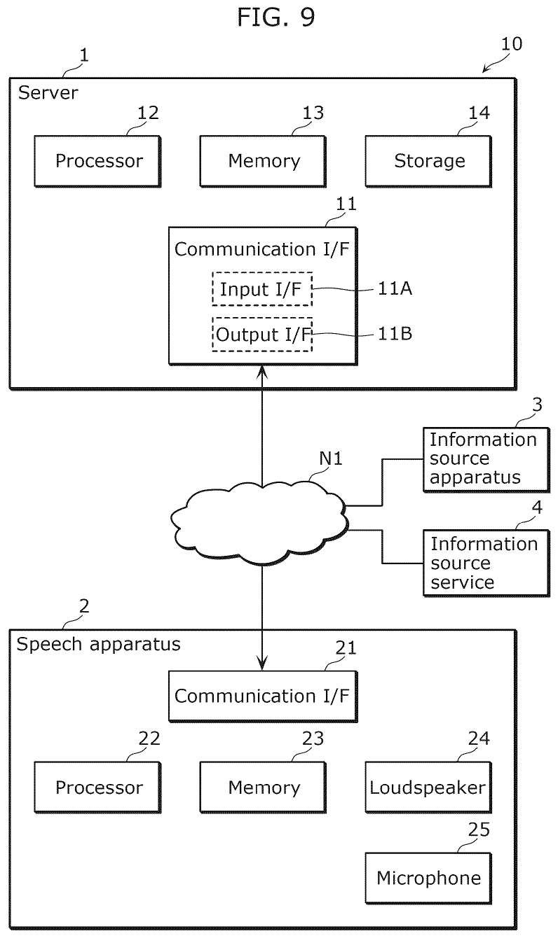

Initially, the entire configuration of the audio processing system according to an embodiment will be described with reference to FIG. 9. FIG. 9 is a block diagram illustrating the entire configuration including the audio processing system according to the embodiment. Audio processing system 10 is a system that causes output of a human speech sound indicating the content of an event from speech apparatus 2 when event information concerning the event is obtained from information source apparatus 3 or information source service 4. In the embodiment, the human speech sound is a human speech sound in Japanese. In the embodiment, audio processing system 10 is implemented by server 1. Server 1 is communicable with speech apparatus 2, information source apparatus 3, and information source service 4 through network N1 such as the Internet. Note that server 1 may communicate with part or all of speech apparatus 2, information source apparatus 3, and information source service 4 through the local area network (LAN).

In the embodiment, server 1 (audio processing system 10) causes one speech apparatus 2 to output the human speech sound indicating the content of the event. Server 1 may cause each of speech apparatuses 2 to output the human speech sound indicating the content of the event. Alternatively, server 1 may cause one or more of speech apparatuses 2 to output the human speech sound indicating the content of the event. Alternatively, server 1 may cause speech apparatuses 2 to output different contents of the event. For example, server 1 may cause one of two speech apparatuses 2 to output the human speech sound indicating the content of an event concerning information source apparatus 3, and may cause the other of two speech apparatuses 2 to output the human speech sound indicating the content of an event concerning different information source apparatus 3.

Speech apparatus 2 is an appliance capable of notifying a user of the content of the event by outputting the human speech sound indicating the content of the event that has occurred in information source apparatus 3 or information source service 4. The notification by speech apparatus 2 may be performed by displaying a character string or an image on a display included in speech apparatus 2.

For example, speech apparatus 2 is an appliance that is disposed in a facility where a user lives, and has the above-mentioned sound output function. In the embodiment, speech apparatus 2 is a home appliance. Specifically, examples of speech apparatus 2 include smart loudspeakers, television receivers, lighting apparatuses, pet cameras, master intercom stations, intercom substations, air conditioners, and robot vacuum cleaners. Note that speech apparatus 2 may be a mobile information appliance carried by the user, such as a portable television receiver, a smartphone, a tablet terminal, or a laptop personal computer.

Information source apparatus 3 is an appliance functioning as an information source of the speech from speech apparatus 2. In the embodiment, information source apparatus 3 is a home appliance. Specifically, information source apparatus 3 is an air conditioner, a laundry machine, a vacuum cleaner, a robot vacuum cleaner, a dish washer, a refrigerator, a rice cooker, or a microwave oven, for example. Examples of events occurring in information source apparatus 3 include the start or end of an operation by information source apparatus 3, an occurrence of an error in information source apparatus 3, and maintenance of information source apparatus 3. Although FIG. 9 illustrates one information source apparatus 3, a plurality of source apparatuses 3 may be included.

Information source service 4 is a service functioning as a service as an information source of the speech from speech apparatus 2, and is a service provided to a user from a server operated by a service provider, for example. Information source service 4 is a transportation service, a weather forecast service, a schedule management service, or a traffic information providing service, for example. Examples of events occurring in information source service 4 include the start or end of a service by information source service 4, and occurrence of an error in information source service 4. Although FIG. 9 illustrates one information source service 4, a plurality of information source services 4 may be included.

### 2-2. Configuration of Server

Next, the configuration of server 1 will be specifically described. As illustrated in FIG. 9, server 1 includes communication interface (hereinafter, referred to as “communication I/F (Interface)”) 11, processor 12, memory 13, and storage 14.

Communication I/F 11 is a wireless communication interface, for example, and receives signals transmitted from information source apparatus 3 and information source service 4 by communicating with information source apparatus 3 or information source service 4 through network N1 based on a wireless communications standard such as Wi-Fi (registered trademark). By communicating with speech apparatus 2 through network N1 based on a wireless communications standard such as Wi-Fi (registered trademark), communication I/F 11 transmits a signal to speech apparatus 2, and receives a signal transmitted from speech apparatus 2.

Communication I/F 11 has the functions of both of an input interface (hereinafter, referred to as “input I/F”) 11A and an output interface (hereinafter, referred to as “output I/F”) 11B. Input I/F 11A obtains event information concerning an event from information source apparatus 3 or information source service 4 by receiving a signal transmitted from information source apparatus 3 or information source service 4.

In the embodiment, input I/F 11A further obtains sound collection information obtained by collecting sounds around speech apparatus 2. The sound collection information is, for example, information concerning sound data generated by collecting sounds by microphone 25 (described later) included in speech apparatus 2. The sounds around speech apparatus 2 become noises that cause difficulties in hearing the human speech sound by the user when speech apparatus 2 outputs the human speech sound indicating the content of the event. Input I/F 11A obtains the sound collection information by receiving the sound data transmitted as the sound collection information from speech apparatus 2.

Output I/F 11B outputs the audio signal corrected by processor 12 by transmitting a signal to speech apparatus 2. Output I/F 11B outputs an instruction signal to instruct speech apparatus 2 to collect sounds therearound by transmitting a signal to speech apparatus 2.

For example, processor 12 is a central processing unit (CPU) or a digital signal processor (DSP), and performs information processing concerning transmission and reception of signals using communication I/F 11 and information processing to generate and correct the audio signal based on event information obtained by communication I/F 11. The processing concerning transmission and reception of signals and the information processing to generate and correct the audio signal are both implemented by processor 12 executing a computer program stored in memory 13. Processor 12 is an example of a signal processing circuit of audio processing system 10.

Memory 13 is a storage that stores a variety of items of information needed for execution of the information processing by processor 12 and a computer program to be executed by processor 12. Memory 13 is implemented by a semiconductor memory, for example.

Storage 14 is a device that stores a database referred by processor 12 when it executes the information processing to generate and correct the audio signal. Storage 14 is a hard disk or a semiconductor memory such as a solid state drive (SSD), for example.

### 2-3. Configuration of Speech Apparatus

Next, the configuration of speech apparatus 2 will be specifically described.

As illustrated in FIG. 9, speech apparatus 2 includes communication I/F 21, processor 22, memory 23, loudspeaker 24, and microphone 25. Depending on the type, speech apparatus 2 need not to include microphone 25. Hereinafter, unless otherwise specified, the embodiment will be described in which speech apparatus 2 includes microphone 25.

For example, communication I/F 21 is a wireless communication interface, and receives the signal transmitted from server 1 and transmits the signal to server 1 by communicating with server 1 through network N1 based on the wireless communications standard such as Wi-Fi (registered trademark).

For example, processor 22 is a CPU or a DSP, and performs the information processing to cause loudspeaker 24 to output the human speech sound based on information processing concerning transmission and reception of signals using communication I/F 21, information processing to cause microphone 25 to collect sounds around speech apparatus 2 based on the instruction signal received by communication I/F 21, and the audio signal received by communication I/F 21. The information processing concerning transmission and reception of signals, the information processing to cause the human speech sound to be output, and the information processing to cause the sounds around speech apparatus 2 to be collected are all implemented by processor 22 executing a computer program stored in memory 23.

Memory 23 is a storage that stores a variety of items of information needed for execution of the information processing by processor 22 and a computer program to be executed by processor 22. Memory 23 is implemented by a semiconductor memory, for example.

Loudspeaker 24 reproduces the human speech sound based on the audio signal received by communication I/F 21. In the embodiment, loudspeaker 24 converts the audio signal into the human speech sound, and outputs the human speech sound converted.

Microphone 25 collects sounds around speech apparatus 2, and generates sound data. In the embodiment, microphone 25 does not always collect sounds around speech apparatus 2, but collects sounds around speech apparatus 2 only when it is instructed to collect sound by server 1 (audio processing system 10). The sound data generated by microphone 25 is transmitted as the sound collection information to server 1 through communication I/F 21.

### 2-4. Generation and Correction of Audio Signal

Next, information processing to generate and correct the audio signal by processor 12 of server 1 (audio processing system 10) will be specifically described.

Initially, after communication I/F 11 (input I/F 11A) obtains the event information, processor 12 determines speech apparatus 2 which is caused to output the human speech sound indicating the content of the event. When only one speech apparatus 2 is present, processor 12 determines to cause one speech apparatus 2 to output the human speech sound. When a plurality of speech apparatuses 2 is present, processor 12 determines to cause predetermined speech apparatus 2 among the plurality of speech apparatuses 2 to output the human speech sound. At this time, speech apparatus 2 caused to output the human speech sound is not limited to one speech apparatus 2, and a plurality of speech apparatuses 2 may be caused to output the human speech sound.

Next, processor 12 outputs an instruction signal to collect sounds around speech apparatus 2, through communication I/F 11 (output I/F 11B) to speech apparatus 2 determined. Thereby, processor 12 obtains the sound collection information through communication I/F 11 (input I/F 11A) from speech apparatus 2 determined. When speech apparatus 2 determined does not include microphone 25, processor 12 does not obtain the sound collection information from speech apparatus 2 determined.

Next, processor 12 determines the character string indicating the content of the event, based on the event information obtained. For example, when event information indicating the end of a washing operation is obtained from a laundry machine as information source apparatus 3, processor 12 determines the character string such that “washing by the laundry machine is ended”. In the embodiment, processor 12 automatically generates the character string based on the event information using an appropriate automatic generation algorithm.

Processor 12 may determine the character string, for example, by referring to the database stored in storage 14 and reading out the character string corresponding to the obtained event information. In this case, the database preliminarily stores items of data in which the contents of the events are associated with the character strings corresponding to the events, respectively.

Next, processor 12 divides the determined character string into one or more sub-character strings using an appropriate algorithm. In the embodiment, processor 12 divides the determined character string into one or more sub-character strings based on syllables. Here, a syllable is one of segment units for dividing a continuing language sound, and is a kind of hearing unit of the human speech sound. For example, the syllables include a consonant, a vowel, a consonant+a vowel, a vowel+a consonant, and a consonant+a vowel+a consonant.

In the embodiment, as an example, processor 12 divides the determined character string into one or more sub-character strings according to the following rules. First, processor 12 basically divides the character string into one or more sub-character strings per each consonant and each vowel, and for long sounds, Japanese glottal stops, and Japanese syllabic nasal, it regards a sound and a sound immediately before it as one sub-character string. Note that processor 12 may regard a combination of a vowel and a consonant immediately before it as one sub-character string. For example, when the character string contains “laundry machine (sentakuki)”, processor 12 divides the character string into four sub-character strings “sen”, “ta”, “ku”, and “ki”.

Next, processor 12 determines a first filter to be applied for each sub-character string. Here, the first filter is a filter according to the feature of the consonant, and is a filter for amplifying the power of the frequency domain according to the feature of the consonant to emphasize the consonant. Processor 12 does not apply the first filter to the sub-character string composed only of vowels.

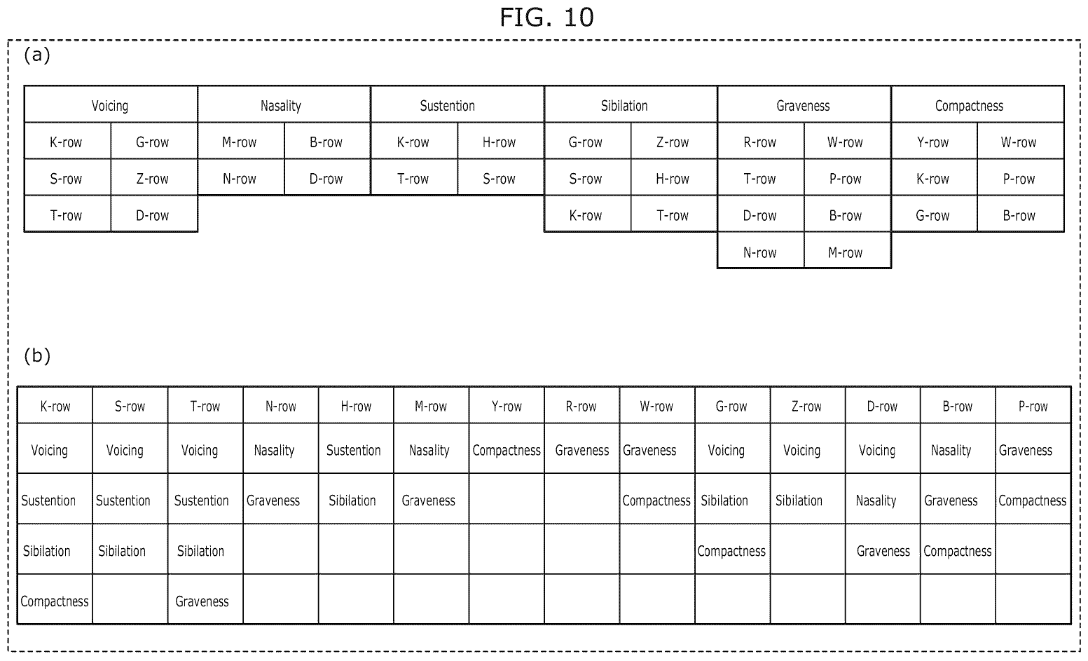

FIG. 10 is a diagram illustrating the correlation between the consonants and the features of the consonants. (a) of FIG. 10 is a table listing the consonants corresponding to the features (voicing, nasality, sustention, sibilation, graveness, and compactness) of the consonants. For example, the consonants having voicing as a feature of the consonants are those of k-, s-, t-, g-, z-, and d-rows. (b) of FIG. 10 is a table listing the features of the consonants corresponding to each consonant. For example, the consonant of the k-row has four features of the consonants, i.e., voicing, sustention, sibilation, and compactness.

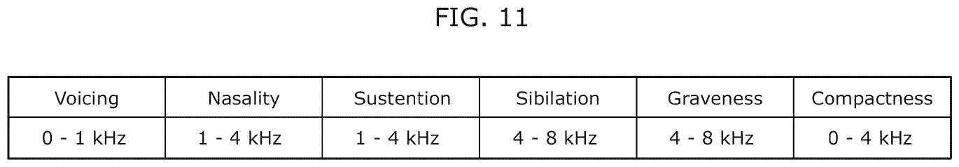

FIG. 11 is a diagram illustrating the correlation between the features of the consonants and the frequency domain. For example, for the consonants having voicing as a feature of the consonants, the frequency domain effective in hearing the one phoneme in the beginning of the word is 0 to 1 kHz. For example, for the consonants having nasality as a feature of the consonants, the frequency domain effective in hearing the one phoneme in the beginning of the word is 1 to 4 kHz.

The data shown in FIGS. 10 and 11 is stored in the database stored in storage 14. Processor 12 determines the first filter to be applied for each sub-character string by referring these items of data stored in the database.

For example, in the case of four sub-character strings “sen”, “ta”, “ku”, and “ki”, the sub-character string “sen” contains “se” corresponding to the s-row. Thus, processor 12 identifies voicing, sustention, and sibilation as the features of the consonant corresponding to the s-row based on the correlation illustrated in FIG. 10. Then, processor 12 synthesizes a filter to amplify the power of the frequency domain corresponding to the voicing, a filter to amplify the power of the frequency domain corresponding to the sustention, and a filter to amplify the power of the frequency domain corresponding to the sibilation, and determines the synthesized filter as the first filter.

Since the sub-character string “ta” corresponds to the t-row, processor 12 identifies voicing, sustention, sibilation, and graveness as the features of the consonant corresponding to the t-row based on the correlation illustrated in FIG. 10. Then, processor 12 synthesizes a filter to amplify power of the frequency domain corresponding to the voicing, a filter to amplify power of the frequency domain corresponding to the sustention, a filter to amplify power of the frequency domain corresponding to the sibilation, and a filter to amplify power of the frequency domain corresponding to the graveness, and determines the synthesized filter as the first filter.

Since the sub-character strings “ku” and “ki” correspond to the k-row, processor 12 identifies voicing, sustention, sibilation, and compactness as the features of the consonant corresponding to the k-row based on the correlation illustrated in FIG. 10. Then, for these sub-character strings, processor 12 synthesizes a filter to amplify power of the frequency domain corresponding to the voicing, a filter to amplify power of the frequency domain corresponding to the sustention, a filter to amplify power of the frequency domain corresponding to the sibilation, and a filter to amplify the power of the frequency domain corresponding to the compactness, and determines the synthesized filter as the first filter.

When a plurality of features of the consonant is present for each sub-character string, processor 12 may determine filters corresponding to the respective features of the consonant as the first filters without synthesizing these filters.

Next, processor 12 generates an audio signal from the determined character string using an algorithm to generate an appropriate mechanical sound. In the embodiment, processor 12 generates the audio signal with a female voice in consideration of the knowledge that the intelligibility of the human speech sound is slightly increased with a female compared to a male voice, which is described in [1. Underlying Knowledge Forming Basis of the Present Disclosure]. Processor 12 may generate the audio signal with a male voice.

Next, processor 12 executes processing to correct the generated audio signal. In the embodiment, processor 12 executes first filter processing to apply the first filter to the generated audio signal, second filter processing to apply the second filter, and third filter processing to apply third filter. These three filter processing steps may be executed in the above-mentioned order, or may be executed in another order.

In the embodiment, before processor 12 executes the first filter processing, processor 12 stores the positions (times) corresponding to the respective sub-character strings in the generated audio signal in memory 13. For example, when an audio signal is generated from a character string “sentakuki”, processor 12 stores, in memory 13, the sub-character string “sen” associated with 0 to 0.7 seconds in the time of the audio signal, the sub-character string “ta” associated with 0.7 to 1 second in the time of the audio signal, the sub-character string “ku” associated with 1 to 1.3 seconds in the time of the audio signal, and the sub-character string “ki” associated with 1.3 to 1.6 seconds in the time of the audio signal.

Then, in the first filter processing, processor 12 applies the first filters determined for the respective sub-character strings to the positions (times) corresponding to the sub-character strings stored in memory 13. For example, when processor 12 applies the first filter to the sub-character string “sen”, processor 12 applies the first filter to 0 to 0.7 seconds in the time of the audio signal.

Processor 12 can execute any processing other than the above-mentioned processing, and for example, may generate the audio signal for the determined character string, by generating audio signals for the respective sub-character strings, applying the first filters thereto, and then linking the audio signals corresponding to all the sub-character strings. In other words, processor 12 may generate the audio signal for the determined character string by generating the audio signals for the respective sub-character strings, and linking the audio signals. At this time, processor 12 may correct each of the audio signals generated in the unit of sub-character string by applying its corresponding first filter thereto. However, when the audio signals are generated for the respective sub-character strings and are linked to each other, a person who hears such a linked audio signal may feel unnaturalness. Thus, the former is desirable.

Here, the second filter is a filter according to the type of speech apparatus 2. Specifically, the second filter is a filter to amplify and emphasize the frequency domain with a relatively low power based on the frequency characteristics of the human speech sound output by speech apparatus 2. For example, when speech apparatus 2 is a robot vacuum cleaner, the human speech sound output by the robot vacuum cleaner has a power in a low frequency domain of 0 to 1 kHz and a high frequency domain of 3 kHz or higher that becomes lower than the power in other frequency domains (see (a) of FIG. 1). In this case, processor 12 determines a filter to amplify the power in the frequency domain of 0 to 1 kHz and the power in the frequency domain of 3 kHz or higher as the second filter.

The third filter is a filter according to the sound collection information. Specifically, the third filter is a filter to amplify and emphasize the frequency domain with a relatively high power based on the frequency characteristics of the sounds around speech apparatus 2 obtained from the sound collection information. For example, assume that a dish washer is operating around speech apparatus 2. In this case, by analyzing the frequency characteristics of the sound data contained in the sound collection information, processor 12 determines that the power in a frequency domain of 0 to 500 Hz is relatively high (see (c) of FIG. 3). Accordingly, in this case, processor 12 determines the filter to amplify the power of the frequency domain of 0 to 500 Hz as the third filter.

When the sounds around speech apparatus 2 are collected, the frequency characteristics of the sounds around speech apparatus 2 may be computed by processor 22 of speech apparatus 2, or may be computed by processor 12 of server 1 that obtains the sound collection information.

Then, processor 12 transmits (outputs) the audio signal corrected by executing the first filter processing, the second filter processing, and the third filter processing, through communication I/F 11 (output I/F 11B) to speech apparatus 2 determined. Thereby, speech apparatus 2 as the target obtains the corrected audio signal through communication I/F 21, and reproduces the human speech sound based on the corrected audio signal from loudspeaker 24.

### 3. Operation

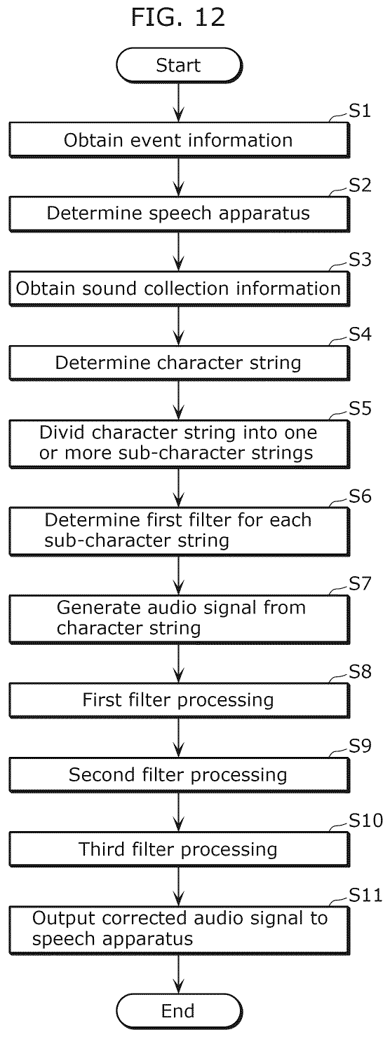

Hereinafter, an example of the operation of server 1 (audio processing system 10) according to the embodiment, i.e., the audio processing method will be described with reference to FIG. 12. FIG. 12 is a flowchart illustrating an example of the operation of audio processing system 10 according to the embodiment. Hereinafter, a case where an event occurs in information source apparatus 3 or information source service 4, and event information is transmitted from the origin of the event occurring through network N1 to server 1 will be described. In the description of the case below, it is assumed that speech apparatus 2 includes microphone 25 and is capable of providing the sound collection information to server 1.

Initially, processor 12 obtains event information through communication I/F 11 (input I/F 11A) (S1). Then, processor 12 determines speech apparatus 2 that outputs the human speech sound indicating the content of the event (S2).

Next, through communication I/F 11 (output I/F 11B), processor 12 outputs an instruction signal to determined speech apparatus 2 to instruct to collect sounds around speech apparatus 2. Thereby, processor 12 obtains the sound collection information through communication I/F 11 (input I/F 11A) from speech apparatus 2 determined (S3)

Next, based on the obtained event information, processor 12 determines the character string indicating the content of the event using an appropriate automatic generation algorithm (S4). Then, using an appropriate algorithm, processor 12 divides the determined character string into one or more sub-character strings (S5). Here, processor 12 divides the determined character string into one or more sub-character strings, based on syllables.

Next, processor 12 determines the first filter to be applied for each of the sub-character strings (S6). Here, processor 12 determines the first filter to be applied for each of the sub-character strings by referring to the data illustrated in FIGS. 10 and 11, the data being stored in the database stored in storage 14.

Next, using an algorithm to generate an appropriate mechanical sound, processor 12 generates the audio signal from the determined character string (S7). Here, processor 12 generates the audio signal with a female voice.

Next, processor 12 executes the first filter processing to apply the first filter for each of the sub-character strings, on the generated audio signal (S8). As already described above, in the embodiment, processor 12 stores the positions (times) corresponding to the respective sub-character strings in the generated audio signal in memory 13. Then, in the first filter processing, processor 12 applies the first filters determined for the respective sub-character strings to the positions (times) corresponding to the sub-character strings stored in memory 13. Processor 12 also executes the second filter processing to apply the second filter on the generated audio signal (S9). Processor 12 executes the third filter processing to apply third filter on the generated audio signal (S10). The order of steps S8, S9, and S10 to be executed is not limited to the order above, and the steps can be executed in any other order.

Then, processor 12 transmits (outputs) the corrected audio signal through communication I/F 11 (output I/F 11B) to speech apparatus 2 determined (S11). Thereby, speech apparatus 2 as the target obtains the corrected audio signal through communication I/F 21, and reproduces the human speech sound based on the corrected audio signal from loudspeaker 24.

### 4. Effects

As described above, in the audio processing method to be executed by a computer such as processor 12, the audio signal is corrected by applying the first filter according to the feature of the consonant for each sub-character string, that is, by amplifying and emphasizing the frequency domain according to the feature of the consonant, and the corrected audio signal is transmitted (output) to speech apparatus 2. For this reason, the user who hears the human speech sound output based on the audio signal corrected by speech apparatus 2 can more easily hear the one phoneme in the beginning of the word for each sub-character string, leading to an improvement in intelligibility of the human speech sound. Accordingly, such an audio processing method is advantageous in that irrespective of the performance of loudspeaker 24 included in speech apparatus 2, the user more easily hears the human speech sound.

In the embodiment, in the audio processing method, the audio signal is further corrected by applying the second filter according to the type of speech apparatus 2, that is, by amplifying and emphasizing the frequency domain with a relatively low power based on the frequency characteristics of the human speech sound output by speech apparatus 2. This allows correction of the human speech sound output by speech apparatus 2 according to the characteristics of speech apparatus 2, and thus is advantageous in that the user further more easily hears the human speech sound output by speech apparatus 2.

In the embodiment, in the audio processing method, the audio signal is further corrected by applying the third filter according to the sound collection information, that is, by amplifying and emphasizing the frequency domain with a relatively high power based on the frequency characteristics of the sounds around speech apparatus 2. This allows correction of the human speech sound output by speech apparatus 2 to prevent the human speech sound from being buried in the sounds around speech apparatus 2, and thus is advantageous in that the user more easily hears the human speech sound output by speech apparatus 2.

### 5. Other Embodiments

The embodiment has been described as above, but the present disclosure is not limited to the above embodiment.

In the above embodiment, processor 12 divides the generated character string into one or more sub-character strings based on syllables, but any other division method can be used. For example, processor 12 may divide the generated character string into one or more sub-character strings based on words. As an example, when the generated character string contains a character string “sentakuki”, processor 12 may divide “sentakuki” as one sub-character string.

For example, processor 12 may divide the generated character string into one or more sub-character strings based on moras (beats). As an example, when the generated character string contains a character string “sentakuki”, processor 12 may divide it into five sub-character strings “se”, “n”, “ta”, “ku”, and “ki”.

For example, processor 12 may divide the generated character string into one or more sub-character strings based on kanji letters forming words. As an example, when the generated character string contains a character string “sentakuki (laundry machine)”, processor 12 may divide it into three sub-character strings “sen”, “taku”, and “ki”.

In the embodiment above, when the sub-character string contains a plurality of features of the consonant, processor 12 determines the filters corresponding to all the features of the consonant as the first filters. For example, processor 12 may determine a priority degree for each of the features of the consonant in the respective sub-character strings of the audio signal.

As an example, processor 12 may determine the filter corresponding to only the feature of the consonant having a high priority degree among the features of the consonant, as the first filter. Here, the expression “a high priority degree” of the feature of the consonant indicates that if the user can hear the consonant, the user can understand the meaning of the character string, or in other words, the possibility that the user misunderstands the meaning of the character string is reduced. Processor 12 may determine the filter corresponding to only the feature of the highest priority degree of the consonant among the features of the consonant, as the first filter, or may determine the filters corresponding to the features of the consonant having a predetermined rank of the priority degree as the first filter.

In the embodiment above, processor 12 executes the first filter processing, the second filter processing, and the third filter processing in the filter processing to correct the audio signal, but the filter processing is not limited to this. For example, processor 12 need not to execute either the second filter processing or the third filter processing, or need not to execute both of them.

In the embodiment above, audio processing system 10 causes speech apparatus 2 to output the human speech sound in Japanese, but the human speech sound is not limited to this. For example, audio processing system 10 may cause speech apparatus 2 to output a human speech sound in another language such as English or Chinese. In this case, processor 12 may determine the first filter according to the language of the human speech sound output by speech apparatus 2 for each of the sub-character strings.

For example, when processor 2 causes speech apparatus 2 to output the human speech sound in English, processor 12 divides the determined character string into one or more sub-character strings in word unit. Here, when the word contains a plurality of syllables, processor 12 may divide the determined character string into one or more sub-character strings in syllable unit. In this case, as in the case of Japanese, processor 12 may determine the first filter according to the features of the consonant (voicing, nasality, sustention, sibilation, graveness, and compactness) for each of the sub-character strings. For example, the words having the voicing as a feature of the consonant are “veal” and “feel”. For example, the words having the nasality as a feature of the consonant are “moot” and “boot”. For example, the words having the sustention as a feature of the consonant are “sheet” and “cheat”. For example, the words having the sibilation as a feature of the consonant are “sing” and “thing”. For example, the words having the graveness as a feature of the consonant are “weed” and “reed”. For example, the words having the compactness as a feature of the consonant are “key” and “tea”.

In the embodiment above, when a plurality of speech apparatuses 2 is present, processor 12 determines that it causes predetermined speech apparatuses 2 to output the human speech sound among the plurality of speech apparatus 2, processor 2 can determine any other speech apparatus. For example, when a detection apparatus capable of obtaining the location of the user is disposed in an environment where a plurality of speech apparatuses 2 is present, processor 12 may determine speech apparatus 2 that outputs the human speech sound, based on the location of the user.

For example, assume that one or more human detecting sensors are arranged in an environment where a plurality of speech apparatuses 2 is arranged, and the memory included in processor 12 stores information indicating each speech apparatus 2 present around the human detecting sensor for each of the human detecting sensors. In this case, processor 12 may obtain the results of detection from the one or more human detecting sensors through communication I/F 11 (input I/F 11A), and may determine that it causes speech apparatus 2 corresponding to the human detecting sensor indicating that the user is present to output the human speech sound.

In the embodiment above, communication I/F 11 of server 1 functions as both of input I/F 11A and output I/F 11B, but any other configuration can be used. For example, input I/F 11A and output I/F 11B may be different interfaces from each other.

In the embodiment above, audio processing system 10 is implemented as a single apparatus, but it may be implemented as a plurality of apparatuses. When audio processing system 10 is implemented as a plurality of apparatuses, the functional components included in audio processing system 10 may be distributed into the plurality of apparatuses in any manner. For example, audio processing system 10 may be distributed into a plurality of servers, and implemented. For example, audio processing system 10 may be distributed into a server and a speech apparatus, and implemented. For example, audio processing system 10 may be implemented only by a speech apparatus.

In the embodiment above, the method for communicating among the apparatuses is not particularly limited. When two apparatuses communicate with each other in the embodiment above, a relay device (not illustrated) may be interposed between the two apparatuses.

The order of the processing steps described in the embodiment above is exemplary. The order of processing steps may be changed, or may be executed in parallel. The processing executed by a specific processor may be executed by another processor. Part of the digital signal processing described in the embodiment above may be implemented by analog signal processing.

In the embodiment above, the components may be implemented by executing software programs suitable for the components. The components may be implemented by a program executor such as a CPU or a processor which reads out and executes software programs recorded in a recording medium such as a hard disk or semiconductor memory.

Alternatively, the components may be implemented by hardware. For example, the components may be circuits (or integrated circuits). These circuits may form a single circuit as a whole, or may be separate circuits. These circuits may be general-purpose circuits, or may be dedicated circuits.

General or specific aspects according to the present disclosure may be implemented by a system, an apparatus, a method, an integrated circuit, a computer program, or a recording medium such as a computer-readable CD-ROM. These aspects may be implemented by any combination of a system, an apparatus, a method, an integrated circuit, a computer program, and a recording medium. For example, the present disclosure may be executed as an audio processing method to be executed by a computer, or may be implemented as a program for causing a computer to execute such an audio processing method. Alternatively, the present disclosure may be implemented as a non-transitory computer-readable recording medium having such a program recorded thereon. Here, the program includes an application program for causing a general-purpose information terminal to function as the audio processing system according to the embodiment above.

Besides, the present disclosure also covers embodiments obtained by subjecting the embodiments to a variety of modifications conceived by persons skilled in the art, and embodiments implemented by any combination of the components and the functions in the embodiments without departing from the gist of the present disclosure.

### Summary

As described above, in the audio processing method according to a first aspect, event information concerning an event is obtained from information source apparatus 3 or information source service 4 (S1), a character string to be spoken by speech apparatus 2 is determined based on the event information obtained (S4), the character string determined is divided into one or more sub-character strings (S5), an audio signal is generated from the character string (S7), the audio signal is corrected by executing, on the audio signal generated, filter processing to apply a first filter according to a feature of a consonant for each of the one or more sub-character strings (S6,S8), and the audio signal corrected is output (S11).

This is advantageous in that the user easily hears the human speech sound irrespective of the performance of loudspeaker 24 included in speech apparatus 2.

In the audio processing method according to a second aspect, in the first aspect, the character string is divided into one or more sub-character strings based on syllables.

This is advantageous in that while the intelligibility of the human speech sound is ensured, the load of the processing to correct the audio signal can be reduced compared to a case where the character string is divided character by character.

In the audio processing method according to a third aspect, in the first or second aspect, a second filter according to the type of speech apparatus 2 is further applied to the audio signal in the filter processing (S9).

This is advantageous in that the human speech sound output by speech apparatus 2 is corrected according to the characteristics of speech apparatus 2, and therefore, the user more easily hears the human speech sound output by speech apparatus 2.

In the audio processing method according to a fourth aspect, in any one of the first to third aspects, sound collection information obtained by collecting sounds around speech apparatus 2 is obtained (S3), and a third filter according to the sound collection information is further applied to the audio signal in the filter processing (S10).

This is advantageous in that the human speech sound output by speech apparatus 2 is corrected to prevent the human speech sound from being buried in the sounds around speech apparatus 2, and therefore the user more easily hears the human speech sound output by speech apparatus 2.

A program according to a fifth aspect causes one or more processors to execute the audio processing method according to any one of the first to fourth aspects.

This is advantageous in that the user easily hears the human speech sound irrespective of the performance of loudspeaker 24 included in speech apparatus 2.

Audio processing system 10 according to a sixth aspect includes processor 12 that corrects an audio signal, and output I/F 11B that outputs the audio signal corrected. Processor 12 is an example of a signal processing circuit. Processor 12 determines a character string to be spoken by speech apparatus 2, based on event information obtained, divides the character string determined into one or more sub-character strings, generates an audio signal from the character string, and corrects the audio signal by executing, on the audio signal generated, filter processing to apply a first filter according to a feature of a consonant for each of the one or more sub-character strings.

This is advantageous in that the user easily hears the human speech sound irrespective of the performance of loudspeaker 24 included in speech apparatus 2.

### Industrial Applicability

The audio processing method according to the present disclosure is applicable to systems and the like that process human speech sounds to be reproduced by loudspeakers.

1. An audio processing method comprising:
obtaining event information concerning an event from an information source apparatus or an information source service;
determining a character string to be spoken by a speech apparatus, based on the event information obtained;
dividing the character string determined into one or more sub-character strings;
generating an audio signal from the character string;
correcting the audio signal by executing, on the audio signal generated, filter processing to apply a first filter according to a feature of a consonant for each of the one or more sub-character strings; and
outputting the audio signal corrected.

2. The audio processing method according to claim 1,
wherein the character string is divided into the one or more sub-character strings based on syllables.

3. The audio processing method according to claim 1,
wherein in the filter processing, a second filter according to a type of the speech apparatus is further applied to the audio signal.

4. The audio processing method according to claim 1 comprising:
obtaining sound collection information obtained by collecting sounds around the speech apparatus; and
further applying a third filter according to the sound collection information to the audio signal in the filter processing.

5. A non-transitory computer-readable recording medium having recorded thereon a program for causing one or more processors to execute the audio processing method according to claim 1.

6. An audio processing system comprising:
an input interface that obtains event information concerning an event from an information source apparatus or an information source service;
a signal processing circuit that corrects an audio signal; and
an output interface that outputs the audio signal corrected,
wherein the signal processing circuit:
determines a character string to be spoken by a speech apparatus, based on the event information obtained;
divides the character string determined into one or more sub-character strings;
generates an audio signal from the character string; and
corrects the audio signal by executing, on the audio signal generated, filter processing to apply a first filter according to a feature of a consonant for each of the one or more sub-character strings.
